(19) United States
(12) Patent Application Publication
(10) Pub. No.: US 2024/0318763 A1
(43) Pub. Date: Sep. 26, 2024

(54) UNDERGROUND PIPE PROTECTION SYSTEM

(71) Applicant: Terence Layne, Dacula, GA (US)

(72) Inventor: Terence Layne, Dacula, GA (US)

(73) Assignee: ROOT ROCK, LLC, Dacula, GA (US)

(21) Appl. No.: 18/587,773

(22) Filed: Feb. 26, 2024

Related U.S. Application Data
(60) Provisional application No. 63/448,412, filed on Feb. 27, 2023.

(51) Int. Cl. F16L 57/02; F16L 41/02; F16L 41/03

(52) U.S. Cl. CPC F16L 57/02; F16L 41/021; F16L 41/03

(57) ABSTRACT

An underground pipe protection system is provided for protecting an underground pipe joint or other component of an underground pipe system. The underground pipe protection system has a a body made up of a top part and a bottom part that is connectable to the top part to define an interior space that is sized, shaped, and adapted to receive an underground pipe joint or other component. The body has a plurality of pipe receiving openings, each opening being sized, shaped, and adapted to receive an underground pipe. The body provides a protective cover around at least a portion of the underground pipe joint or other component that helps protect the underground pipe joint or other component from one or more of root penetration, soil or ground movement, and water damage.

### PRIORITY

The present application claims the benefit of domestic priority based on U.S. Provisional Patent Application No. 63/448,412 filed on Feb. 27, 2023, the entirety of which is incorporated herein by reference.

### BACKGROUND

The use of underground pipes is becoming increasingly ubiquitous. Both professional installers and do-it-yourself homeowners lay pipes in the ground for irrigation systems and the like.

However, underground pipes can, over time, become damaged and start to leak. The leaking can be caused by one or more of several factors. For example, soil or ground compression, rock impingement, and/or entangled roots from trees or other plants can place stress on the pipes. In addition, weather can cause stresses on the pipes. For example, heavy rainfall can lead to erosion and soil movement, and temperature changes can cause expansion and contraction of the pipes and/or of the soil surrounding the pipes. In some regions, seismic activity can cause catastrophic movements that can break or stress the pipes. These and other factors can lead to damaged pipes that can result in leakage. These problems are most prevalent in the vulnerable region of pipe joints.

Underground pipe leakage from pipe damage can be problematic for several reasons. In addition to the reduction in efficient use of water resources which can lead to water shortages and an increased cost of water usage, the leaking can also lead to an exacerbation of the pipe damage. The presence of leaked water in the soil can attract more root growth from trees and other plants seeking out a water source. As the roots grow around and sometimes into the pipes and pipe joints, added stress and damage occurs. In addition, the leaking water can cause erosion of the soil near the leak which can also be stress inducing on the pipes and pipe joints as the supporting soil changes or becomes less stable.

There is therefore a need for a system and/or method that provides protection to underground pipes, especially in the region of underground pipe joints. There is further a need for a system that provides a protective cover to underground irrigation systems. There is a further a need for a system that provides a protective cover to underground pipe joints.

### SUMMARY

The present invention satisfies these needs. In one aspect of the invention, a system provides protection for an underground pipe system.

In another aspect of the invention, a system provides protection for one or more components of an underground pipe system, such as an irrigation system, a water supply system, a sewer or septic system, a gas supply or distribution system, and/or the like.

In another aspect of the invention, a system provides protection for one or more pipe joints in an underground pipe system.

In another aspect of the invention, an underground pipe protection system includes a body with an interior space adapted to receive a pipe joint or other feature to be protected.

In another aspect of the invention, an underground pipe protection system includes a body with an interior space adapted to receive a pipe joint or other feature to be protected, wherein a water resistant connection system is provided.

In another aspect of the invention, an underground pipe protection system comprises a cover that at least partially covers an underground pipe joint to lessen the stress experienced by the joint.

In another aspect of the invention, an underground pipe protection system comprises a cover that at least partially covers an underground pipe joint to lessen the stress experienced by the joint to provide an extra layer of protection around at least a portion of an underground pipe joint.

In another aspect of the invention, an underground pipe protection system comprises a cover that at least partially covers an underground pipe joint to lessen the stress experienced by the joint to provide an extra layer of protection around at least a portion of an underground pipe joint which can be useful to protect against one or more of soil or ground movement caused by compression, rock impingement, roots growth, temperature changes, seismic activity, and other factors that can stress the underground pipe joint and eventually lead to damage or leakage.

In another aspect of the invention, a method of protecting one or more components of an underground pipe system comprises providing an underground pipe protection system as described herein and using the underground pipe protection system as described herein.

In another aspect of the invention, an underground pipe protection system for protecting an underground pipe joint comprises a body comprising a top part and a bottom part that is connectable to the top part to define an interior space that is sized, shaped, and adapted to receive an underground pipe joint; wherein the body comprises a plurality of pipe receiving openings, each opening being sized, shaped, and adapted to receive a pipe leading to the underground pipe joint; and wherein the body provides a protective cover around at least a portion of the underground pipe joint that helps protect the underground pipe joint from one or more of root penetration, soil or ground movement, and water damage.

In another aspect of the invention, an underground pipe protection system for protecting an underground pipe joint comprises a body comprising a top part and a bottom part that is connectable to the top part to define an interior space that is sized, shaped, and adapted to receive an underground pipe joint; wherein the body comprises a plurality of pipe receiving openings, each opening being sized, shaped, and adapted to receive a pipe leading to the underground pipe joint; wherein the body provides a protective cover around at least a portion of the underground pipe joint that helps protect the underground pipe joint from one or more of root penetration, soil or ground movement, and water damage, and wherein at least one of the plurality of pipe-receiving openings includes a portion of the opening in the top part and a portion of the opening in the bottom part.

In another aspect of the invention, an underground pipe protection system for protecting an underground pipe joint comprises a body comprising a top part and a bottom part that is connectable to the top part to define an interior space that is sized, shaped, and adapted to receive an underground pipe joint, wherein the body comprises a plurality of pipe receiving openings, each opening being sized, shaped, and adapted to receive a pipe leading to the underground pipe joint, wherein the body provides a protective cover around at least a portion of the underground pipe joint that helps protect the underground pipe joint from one or more of root penetration, soil or ground movement, and water damage, and wherein at least one of the plurality of pipe-receiving openings is entirely in the top part or bottom part.

In another aspect of the invention, an underground pipe protection system for protecting an underground pipe joint comprises a body comprising a top part and a bottom part that is connectable to the top part to define an interior space that is sized, shaped, and adapted to receive an underground pipe joint; wherein the body comprises a plurality of pipe receiving openings, each opening being sized, shaped, and adapted to receive a pipe leading to the underground pipe joint; wherein the body provides a protective cover around at least a portion of the underground pipe joint that helps protect the underground pipe joint from one or more of root penetration, soil or ground movement, and water damage, and wherein in use the top part can be positioned above, below, to the side, or at any angle relative to the bottom part.

In another aspect of the invention, an underground pipe protection system for protecting an underground pipe joint comprises a body comprising a top part and a bottom part that is connectable to the top part to define an interior space; and a pipe joint adapted to connect two or more underground pipes, the pipe joint being receivable in the interior space of the body, wherein the body comprises a plurality of pipe receiving openings, each opening being sized, shaped, and adapted to receive a pipe leading to the pipe joint, and wherein the body provides a protective cover around at least a portion of the pipe joint when the pipe joint is located underground so that the body helps protect the pipe joint from one or more of root penetration, soil or ground movement, and water damage.

In another aspect of the invention, a method of protecting an underground pipe joint comprises providing a body comprising a top part and a bottom part that is connectable to the top part to define an interior space that is sized, shaped, and adapted to receive an underground pipe joint, wherein the body comprises a plurality of pipe receiving openings, each opening being sized, shaped, and adapted to receive a pipe leading to the underground pipe joint; and positioning the body to receive an underground pipe in each of the plurality of pipe receiving openings and to receiving at least a portion of an underground pipe joint in the interior space, wherein the body provides a protective cover around at least a portion of the underground pipe joint that helps protect the underground pipe joint from one or more of root penetration, soil or ground movement, and water damage.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic above and below ground side view of a version of an underground pipe protection system according to the invention;

FIG. 1B is a schematic above and below ground side view of another version of an underground pipe protection system according to the invention;

FIG. 1C is a schematic perspective view of an irrigation system using one or more underground pipe protection systems of the invention;

FIG. 2A is a schematic perspective side view of a version of an underground pipe protection system of the invention;

FIG. 2B is a schematic exploded perspective view of the underground pipe protection system of FIG. 2A and an underground pipe joint;

FIG. 2C is a schematic perspective view of the assembled underground pipe protection system of FIG. 2B;

FIG. 3A is a schematic perspective side view of another version of an underground pipe protection system of the invention;

FIG. 3B is a schematic exploded perspective view of the underground pipe protection system of FIG. 3A and an underground pipe joint;

FIG. 3C is a schematic perspective view of the assembled underground pipe protection system of FIG. 3B;

FIG. 4A is a schematic perspective side view of another version of an underground pipe protection system of the invention;

FIG. 4B is a schematic exploded perspective view of the underground pipe protection system of FIG. 4A and an underground pipe joint;

FIG. 4C is a schematic perspective view of the assembled underground pipe protection system of FIG. 4B;

FIG. 5A is a schematic perspective side view of another version of an underground pipe protection system of the invention;

FIG. 5B is a schematic exploded perspective view of the underground pipe protection system of FIG. 5A and an underground pipe joint;

FIG. 5C is a schematic perspective view of the assembled underground pipe protection system of FIG. 5B;

FIG. 6A is a schematic partial perspective side view of another version of an underground pipe protection system of the invention;

FIG. 6B is a schematic partial sectional view of the underground pipe protection system of FIG. 6A;

FIG. 7A is a schematic exploded view of another version of an underground pipe protection system and an underground pipe joint;

FIG. 7B is a schematic assembled perspective view of the underground pipe protection system of FIG. 7A;

FIG. 8A is a schematic top view of another version of an underground pipe protection system of the invention deployed on an underground pipe joint;

FIG. 8B is a schematic perspective side view of the underground pipe protection system of FIG. 8A;

FIG. 8C is a schematic partially sectional side view of the underground pipe protection system of FIG. 8A;

FIG. 9 is a schematic exploded view of another version of an underground pipe protection system;

FIG. 10A is a schematic assembled perspective view of the underground pipe protection system of FIG. 9;

FIG. 10B is a schematic assembled top view of the underground pipe protection system of FIG. 9;

FIG. 10C is a schematic assembled side view of the underground pipe protection system of FIG. 9;

FIG. 11A is a schematic assembled perspective view of another version of an underground pipe protection system;

FIG. 11B is a schematic assembled top view of the underground pipe protection system of FIG. 11A;

FIG. 11C is a schematic assembled top view of the underground pipe protection system of FIG. 11A;

FIG. 12 is a schematic exploded view of another version of an underground pipe protection system;

FIG. 13A is a schematic assembled perspective view of the underground pipe protection system of FIG. 12;

FIG. 13B is a schematic assembled top view of the underground pipe protection system of FIG. 12;

FIG. 13C is a schematic assembled side view of the underground pipe protection system of FIG. 12; and

FIG. 13D is a schematic assembled front view of the underground pipe protection system of FIG. 12.

### DESCRIPTION

The present invention relates to a pipe protection system. In particular, the invention relates to a system for protecting underground pipes especially at the joints. Although the underground pipe protection system is illustrated and described in the context of being useful for protecting underground pipes, the present invention can be useful in other instances. Accordingly, the present invention is not intended to be limited to the examples and embodiments described herein.

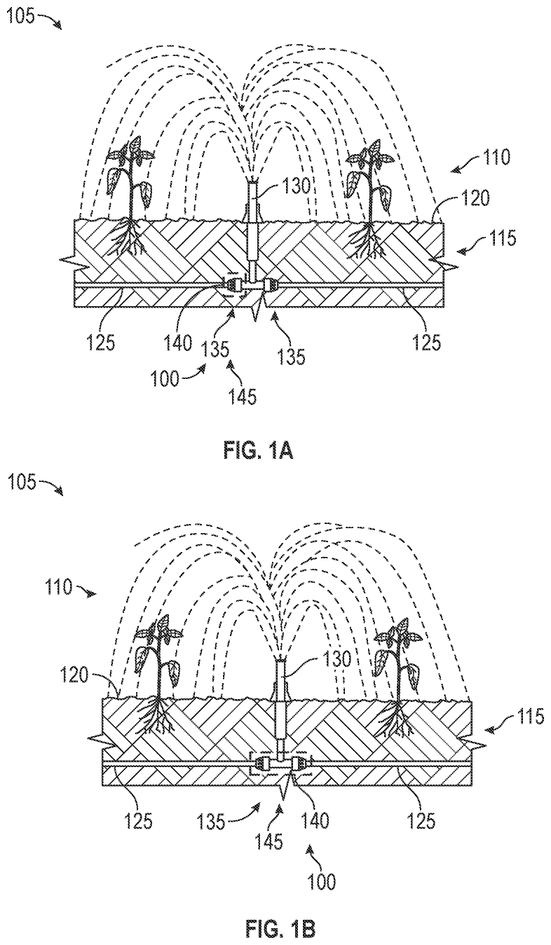

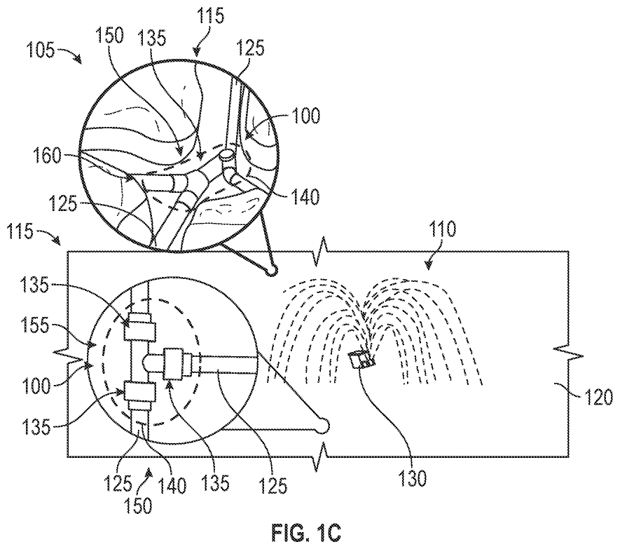

FIG. 1A shows a version of an underground pipe protection system 100 according to the invention. In this version, the underground pipe protection system is being used to protect an irrigation system 105. Irrigation systems 105 typically have an above-ground portion 110 and a below-ground portion 115. Below the ground level 120 is a system of underground pipes 125 that convey water from a water source to the above-ground portion 110. The above-ground portion 110 can include a sprinkler head 130, as shown in FIG. 1A, or any other type of above-ground system, such as a faucet, a drip line, back-flow prevention assembly, irrigation valves, sprinkler solenoids, and the like. One or more underground pipe joints 135 connect underground pipes 125 to other pipes, adapters, and the like. A typical irrigation system 105 will have a number of underground pipes 125 and underground pipe joints 135. The underground pipe protection system 100 includes a body 140 that forms a protective shell that can cover an underground pipe joint 135 to provided added protection to the underground pipe joint 135 during the underground life of the underground pipe joint 135. By underground pipe it is meant any conduit that is adapted to carry water or other liquid or fluid from one point to a second point and wherein at least a portion of the path from the first point to the second point is underground. The underground pipe is typically a continuous piece of material, such as plastic or metal. By underground pipe joint it is meant any connection of a pipe to another pipe or plumbing implement, such as another pipe, adapter, connector, irrigation valve, irrigation solenoid, and the like, and where the connection is intended to be at least partially underground during at least a portion of its life. The connection may be, and typically is, bonded, glued, screwed, or otherwise secured together either permanently or releasably. Thus, a joint is made up of at least two conduits that are either separable from one another or at one time were separate from one another and then connected. The underground pipe protection system 100 covers and protects this connection joint.

The underground pipe protection system 100 of the present invention can take any of several useful forms. For example, in the version of FIG. 1A, the underground pipe protection system 100 includes a body 140 that covers a single underground pipe joint 135. In another version, such as shown in FIG. 1B, the underground pipe protection system 100 has a body 140 that covers multiple underground pipe joints 135. The body 140 of the underground pipe protection system 100 can also be any suitable size and shape. For example, the body 140 can be a box-shaped body 145, as shown in FIGS. 1A and 1B. Alternatively, the body 140 can be curved or contoured to for a curved-shaped body 150, as shown in FIG. 1C, or a combination of the two. As also shown in FIG. 1C, a curved-shaped body 150 can be a conventional shape, such as the oval cross-sectional shaped body 155, or can be a contoured shaped body 160 that is shaped to fit a particular location or configuration. It may also be desirable, as shown in FIG. 1C, to have different shaped bodies to protect different shaped underground pipe joints even within the same irrigation system. It is to be understood that whenever the body 140 is mentioned herein, the body 140 can be any one of these shapes, at least partially or completely, and/or can be a combination of these shapes.

Regardless of the size or shape, the underground pipe protection system 100 provides an extra layer of protection around at least a portion of an underground pipe joint 135. This added protection is useful in many ways. Since underground pipe joints 135 are not continuous pieces of material but are instead connected pieces, they are more vulnerable when stressed than other parts of the below ground portion 115 of the irrigation system 105. As discussed above, soil or ground movement caused by compression, rock impingement, roots growth, temperature changes, seismic activity, and other factors can stress the underground pipe joint 135 and can eventually lead to leakage at the underground pipe joint 135. First, the underground pipe protection system 100 provides protection from these stresses and helps prevent the stresses from causing damage at the underground pipe joint 135. For example, by covering the underground pipe joint 135 the body 140 of the underground pipe protection system 100 can absorb some of the movement of the ground and roots and can thus help to lessen the stress that is applied directly to the underground pipe joint 135. Similarly, the extra layer provides thermal protection and can reduce the temperature-caused compression and expansion at the underground pipe joint 135. Second, after damage and/or a leak eventually develops at an underground pipe joint 135, the underground pipe protection system 100 continues to provide protection. Not only does the underground pipe protection system 100 continue to provide structural and thermal support to help prevent worsening of the damage, the underground pipe protection system 100 also help block nearby roots from entering the pipe at the damaged joint as the root seeks out a water source. In the absence of this root blockage, the penetration of the root into the pipe can accelerate the damage to the underground pipe joint 135 and hasten the failure of the joint necessitating the need to dig up and replace the underground pipe joint 135. With the underground pipe protection system 100, the life of the underground pipe joint 135 can be extended. In this regard, the body 140 and/or the pipe protection system 100 are not intended to serve as pipes that carry water or other fluid but instead to form a non-fluid-carrying protective structure for one or more components of an underground pipe system.

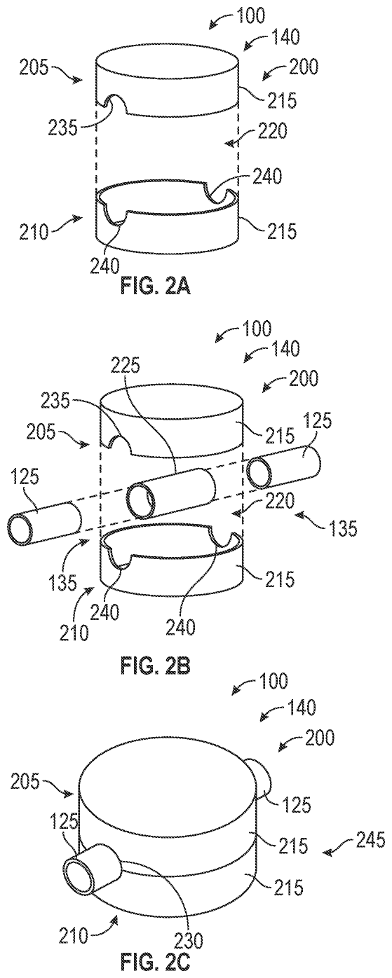

FIGS. 2A, 2B, and 2C illustrate a version of an underground pipe protection system 100 of the invention. In this version, the body 140 of the underground pipe protection system 100 is a multi-part body 200. In the particular version shown, the multi-part body 200 has a top part 205 and a bottom part 210 that are initially separate from one another. The top part 205 and the bottom part 210 each have a hard outer shell 215 that can be joined together. The top part 205 and the bottom part 210 also together when joined define a hollow interior space 220 that is sized and shaped to receive a portion of an underground pipe system therein. In this version shown, the interior space 220 is adapted to receive a portion of the underground pipe system that includes an underground pipe joint 135. For example, the interior space 220 can receive an adapter or connector 225 that is connectable to a pipe 125 to form an underground pipe joint. In the particular version shown, a plurality of joints are created and received within the interior space 220 by the adapter or connector 225 connecting two underground pipes 125. The body 140 includes one or more pipe receiving openings 230 that are sized and shaped to receive a pipe 125 as best seen in the assembled version of FIG. 2C. In this version, the pipe receiving opening 230 is formed by the joining together of a top part pipe opening portion 235 and a bottom part pipe opening portion 240. In the version shown, two pipe receiving openings 230 receive two pipes 125 that are connected at the adapter or connector 225 to form two underground pipe joints 135. As can be seen in FIG. 2C, when the top part 205 and the bottom part 210 are joined together protective shell 245 is formed that can contain an underground pipe joint 135 within the interior space 220. As will be understood, each of the top part 205 and bottom part 210 can themselves be made of multiple parts.

The expressions “top” and “bottom” are used herein solely as relative terms and are not intended to necessarily imply any particular orientation during use. In that regard, the top part 205 and the bottom part 210 are so named because of their relative orientation to one another in FIGS. 2A through 2C and in other figures which show the parts being used with horizontal pipes. However, in use top part 205 could be vertically above or vertically below the bottom part 205, or the top part 205 could be horizontally beside or at a diagonal to the bottom part 210 depending on the pipe situation and the need. Accordingly, the terms top part and bottom part are intended to connote that the top part is capable of being positioned vertically above the bottom part either in use or before or after use.

When the top part 205 is joined to the bottom part 210, the protective shell 245 provides a protective cover that is formed around at least a portion of the one or more underground pipe joints 135. The top part 205 and the bottom part 210 can be joined together by any suitable means, such as by pipe cement or adhesive. The protective cover lessens the stress on the underground pipe joints 135 by reducing the motional and/or thermal stress on the joints, as discussed above.

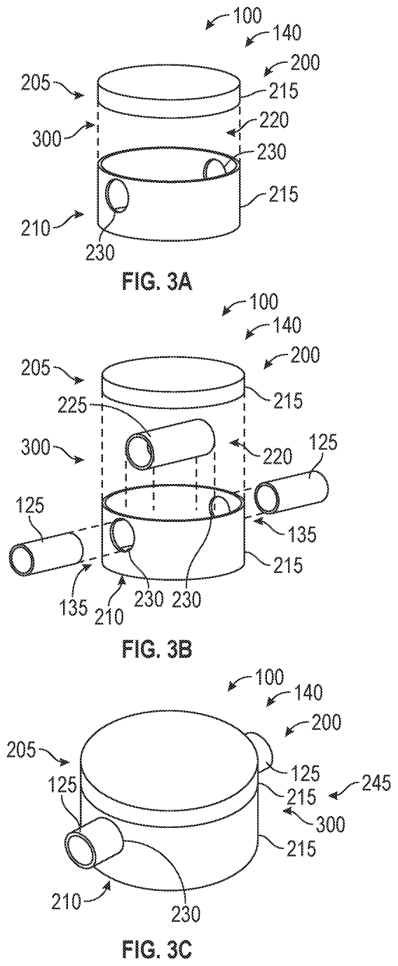

Another version of the underground pipe protection system 100 is shown in FIGS. 3A, 3B, and 3C. This version is similar to the version of FIGS. 2A, 2B, and 2C, but in this version, the entire pipe opening 230 is in the bottom part 210. Alternatively, the entire pipe opening 230 can be provided in the top part 205. In this version, a removeable connection 300 is provided so that the top part 205 and the bottom part 210 can be removably connectable to one another. For example, in one particular version, the top part 205 can be rotatably connectable to the bottom part 210, such as by providing engageable threads or the like. In this way the top part 205 can be connected to the bottom part by rotation in a first direction and can be disconnected by rotation in the opposite direction. This version with a removable connection 300 is advantageous in that it allows a user to gain access to a pipe joint 135 after the pipe protection system 100 has been installed. On the other hand, the version of FIGS. 2A, 2B, and 2C is useful when a pipe protection system 100 is to be applied to an existing pipe joint 135 without having to disconnect the existing pipe joint 135. Alternatively, the top part 205 and bottom part 210 of the version of FIGS. 3A, 3B, and 3C can be connected by pipe cement or other adhesive if it is desired to have a more permanent connection.

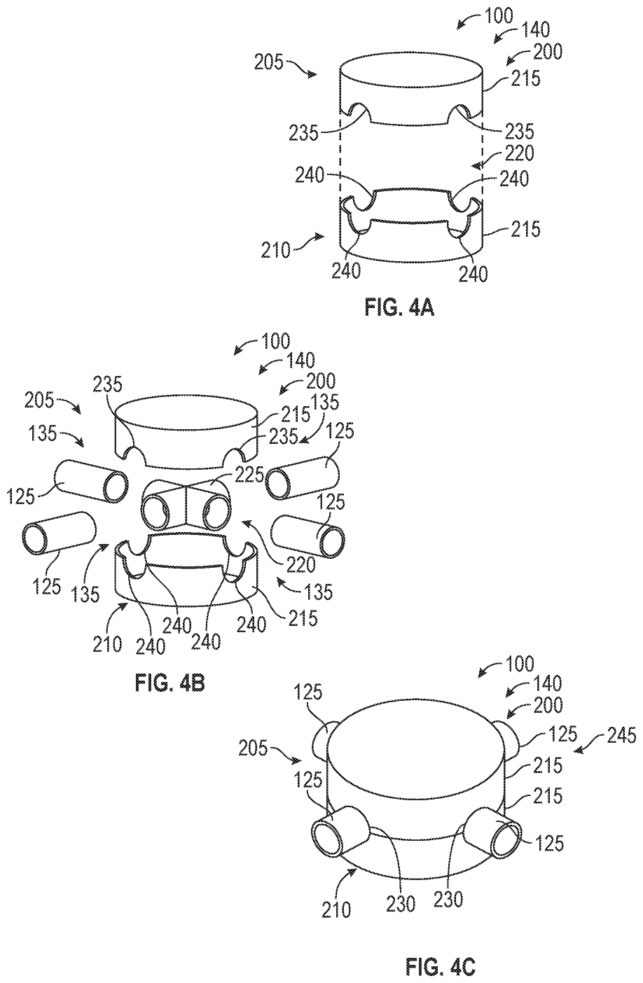

Another version of the underground pipe protection system 100 is shown in FIGS. 4A, 4B, and 4C. This version is similar to the version of FIGS. 2A, 2B, and 2C, but in this version, the connecter 225 is adapted to connect more than two underground pipes 125, and in the particular version shown is adapted to connect four underground pipe. As can be seen, there is a corresponding number of pipe openings 230 provided in the body 240 of the pipe protection system 100 to match the number of underground pipes 125. In one particular version, the pipe protection system 100 according to this version can be provided with knockouts that cover the pipe openings 230 prior to use. A knockout covers each opening 230 or the top portion 235 and bottom portion 240 of each opening 230 but is scored or perforated in a manner that allow it to be easily knocked out to create the opening 230. In this way, a body 240 can be provided with four or more potential opening 230 and a user can select the number of knockouts to remove depending on the number of pipes to be protected by the underground pipe protection system 100.

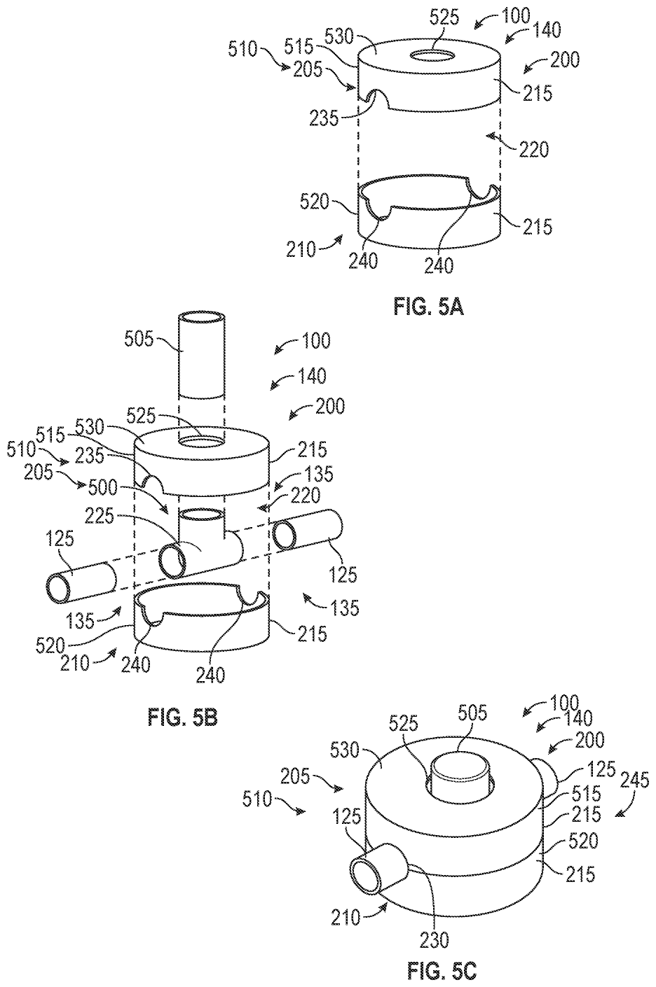

Another version of the underground pipe protection system 100 is shown in FIGS. 5A, 5B, and 5C. This version is similar to the version of FIGS. 2A, 2B, and 2C, but in this version the underground pipe protector body 140 is adapted to contain and protect a connector 225 that include an orthogonal connector portion 500 that connects to a vertical pipe 505 that is adapted to extend to an above-ground portion. For example, the vertical pipe 505 can lead to a sprinkler head 130 or the like as discussed above. In this version, the pipe-receiving openings 230 are provided in a sidewall portion 510 of the body 140. The sidewall portion 510 includes a top part sidewall portion 515 and a bottom part sidewall portion 520. In the particular version of FIGS. 5A through 5C, the sidewall portion 510 is round or circular in cross-section, but it can assume any shape suitable for containing the connector 225. The one or more pipe-receiving openings 230 in the sidewall portion 510 are adapted to receive substantially horizontally extending pipes 125. A vertical opening 525 is provided in a top surface 530 of the top part 205 to allow the vertical pipe 505 to extend therethrough. As is clear, this version can be used with any number of underground pipes 125, including the version of FIGS. 5A, 5B, and 5C with two underground pipes 125, or with a single underground pipe 125, or with more than two underground pipes 125. As is also clear, though the pipe-receiving openings 230 are shown in FIGS. 5A through 5C as having a top part pipe opening portion 235 and a bottom part pipe opening portion 240, the entirety of the pipe-receiving opening 230 in accordance with this version of the invention can be in the top part 205 and/or in the bottom part 210 of the body 140.

As discussed above, the underground pipe protection system 100 provides an extra layer of protection around at least a portion of an underground pipe joint 135. Even a loose fit between the underground pipes 125 and the openings 230 can provide significant protection for the pipe joint 135. However, the protection can be further improved by having tight fits between the parts. This further discourages the ingress of roots and the like. In one version, the underground pipe protection system 100 can be water tight and can thus resist the passage of water into the interior of the pipe protection system 100 and thus reduce or prevent the amount of water that comes in contact with the outside of the pipe joint 135. In addition, if there is leakage from the pipe joint 135, the escaping water is less likely to make it past the underground pipe protection system 100 and is less likely to attract the attention of roots.

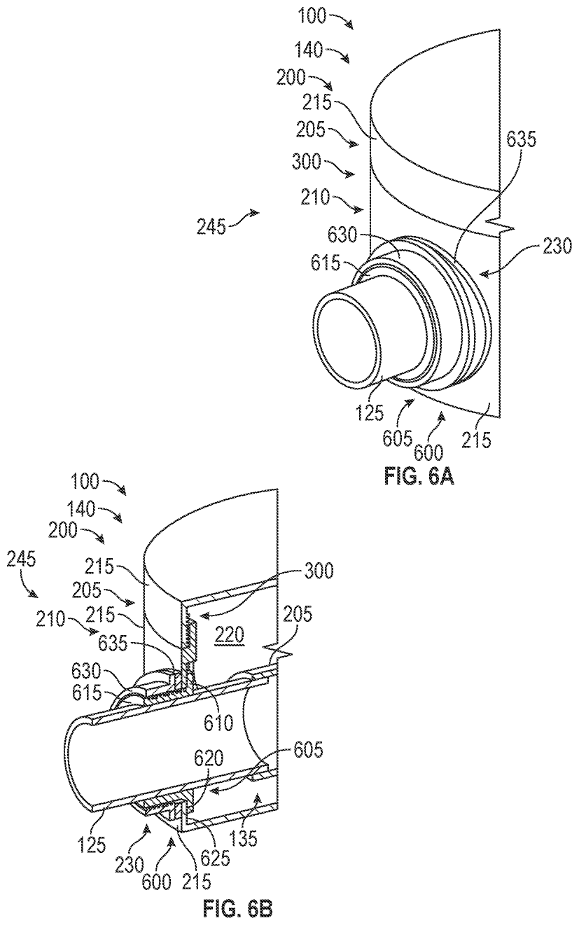

FIGS. 6A and 6B illustrate a water-resistant or water-tight version of the underground pipe protection system 100. In this version, one or more of the openings 230 is provided with a water-resistant connection system 600. The water-resistant connection system 600 reduces the passage of water across the opening 230. In one version, the water-resistant connection system 600 reduces the amount of water that passes across the opening over an underground pipe protection system that has no water-resistant connection 600. In another version, the water-resistant connection system 600 reduces the amount of water that passes across the opening so that there is at least a 50% reduction in water passage over an underground pipe protection system that has no water-resistant connection 600 under normal operating conditions. In another version, the water-resistant connection system 600 reduces the amount of water that passes across the opening so that there is at least a 90% reduction in water passage over an underground pipe protection system that has no water-resistant connection 600 under normal operating conditions.

In the particular version shown in FIGS. 6A and 6B, the water-resistant connection system 600 includes a flanged member 605 that has a flange 610 on one end and a threaded shank 615 extending from the flange 610. The shank 615 is sized to be able to fit within the opening 230 in the body 140. The flange 610 is sized so as to be larger than the opening 230 and has a surface 620 that is adapted to contact an interior wall 625 of the body 140 at a position near the opening 230 so that the shank 610 can extend through the opening 230 but the flange cannot. The flange 610 can have a shape that is contoured to match the shape of the interior wall 625. A locking nut 630 is sized to be receivable on the shank 615 and has threads to threadingly engage the threads of the shank 615. Rotation of the locking nut 630 on the shank 615 of the flanged body 605 moves the locking nut 630 along the shank 615 towards the flange 610. Thus, by advancing the locking nut 630 towards the flange 610, the wall of the body 140 near the opening 230 can be squeezed between the locking nut 630 and the flange 610. By making the connection sufficiently tight, the connection becomes water resistant. Additionally, water resistance can be provided by providing a gasket 635 between the locking nut 630 and the wall of the body 240 and/or between the flange 610 and the interior wall 625. The gasket 635 is sufficiently flexible, compressible, and/or water tight to increase the water resistance of the water-resistant connection system 600. The gasket 635 can optionally be shaped to match the contour of the wall of the body 240 near the opening 230.

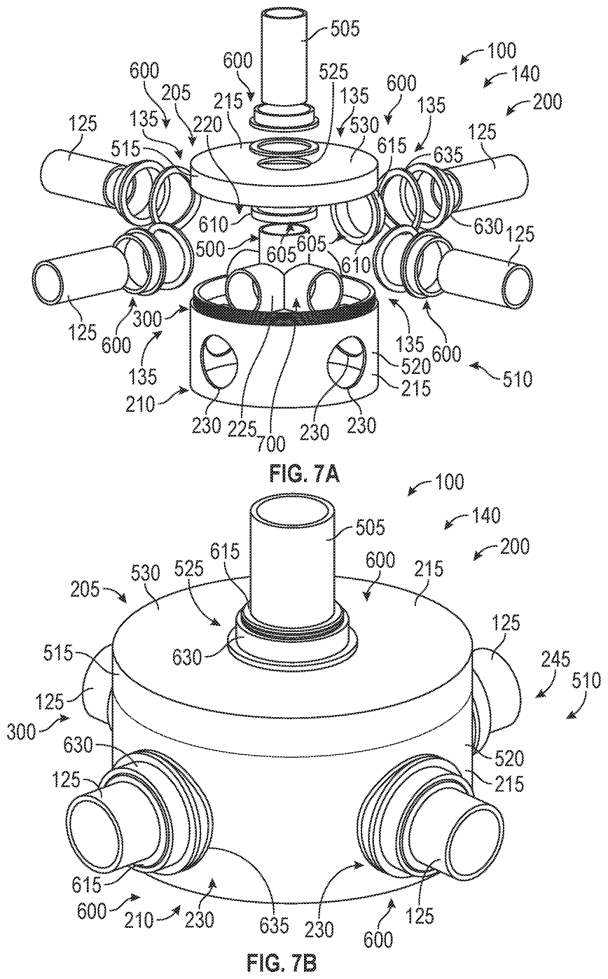

FIGS. 7A and 7B show an underground pipe protection system 100 with water resistant connection systems 600 for providing water-resistant protection for a five-opening tubing connector 700. The water-resistant connection systems 600 can be provided at each of the five openings, as shown. Some of the parts, such as some of the flanged bodies are not shown for clarity.

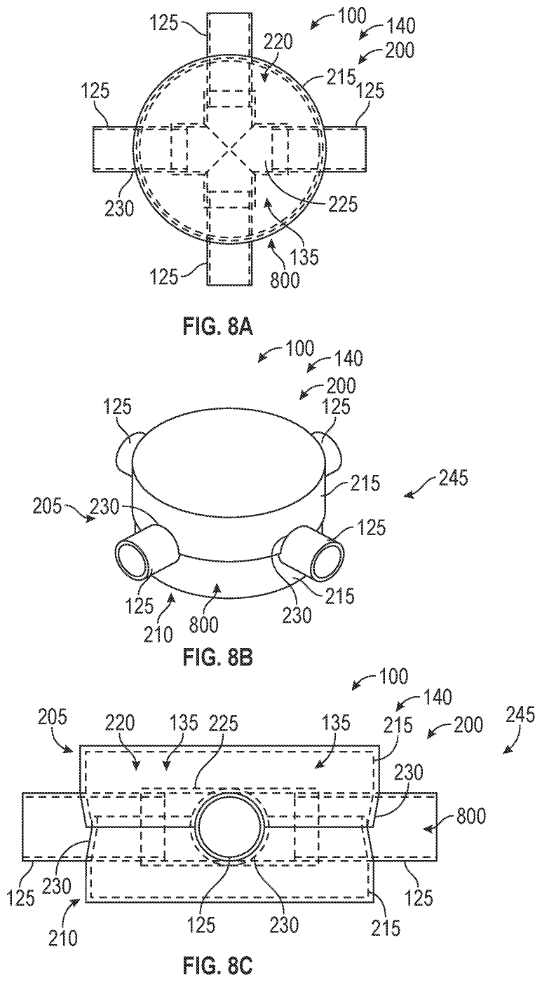

Another version of the underground pipe protection system 100 is shown in FIGS. 8A, 8B, and 8C. This version is similar to the version of FIGS. 2A, 2B, and 2C, but in this version the top part 205 and the bottom part 210 of the body 140 are connectable by a press-fit arrangement 800. Optionally, pipe cement or other adhesive can also be used to make the connection more permanent.

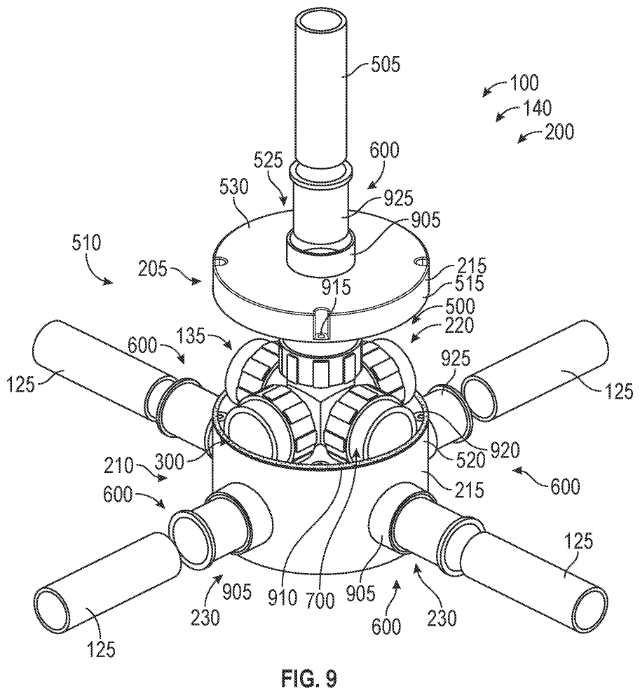

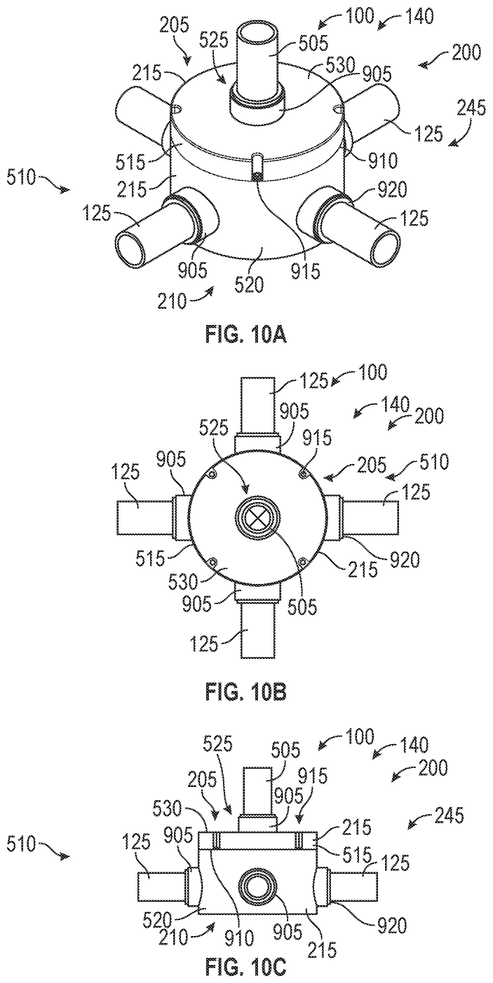

FIGS. 9 and 10A, 10B, and 10C show another version of an underground pipe protection system 100. In this version, water resistant connection system 600 comprises a slip insert flange 905 that allows inserted pipes to have a watertight fit within the body 140. A gasket 910 provides a watertight seal between the top part 205 and the bottom part 210. A socket head cap screw system 915 allows the top part 205 to be connected to the bottom part 210 by being screwed into a threaded insert 920 to compress the gasket 910. A pipe reducer 925 optionally allows the unit to accommodate different sized pipes. The version of FIGS. 9, 10A, 10B and 10C is particularly useful as a water supply underground pipe protection system. The version of FIGS. 9, 10A, 10B, and 10C is particularly capable of accommodating larger compression pipe fittings, such as the five-opening tubing connector 700 for two-inch pipe as shown.

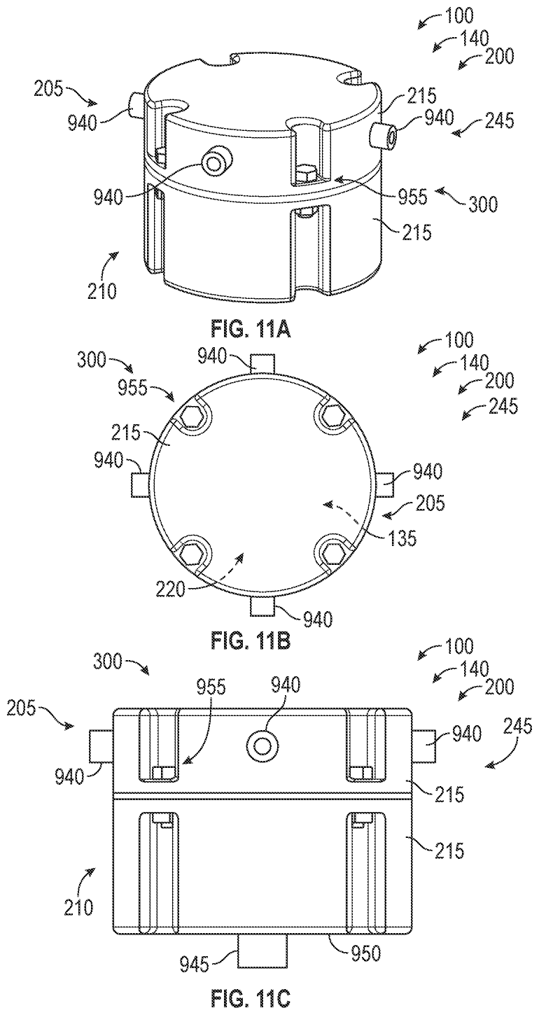

FIGS. 11A through 11C show another version of an underground pipe protection system 100 that is particularly useful for protecting an underground dripline system. The underground pipe protection system 100 of this version includes one or more dripline distribution hose slip inserts 940 and a dripline irrigation main water pipe slip insert 945 that extends through a bottom surface 950 of the bottom part 210 of the body 140. This version gives a dripline outlet emitter within the body 140 added protection from damage by natural elements such as weather and direct sunlight. A nut and bolt connection system 955 for connecting the top part 205 to the bottom part 210 is also shown.

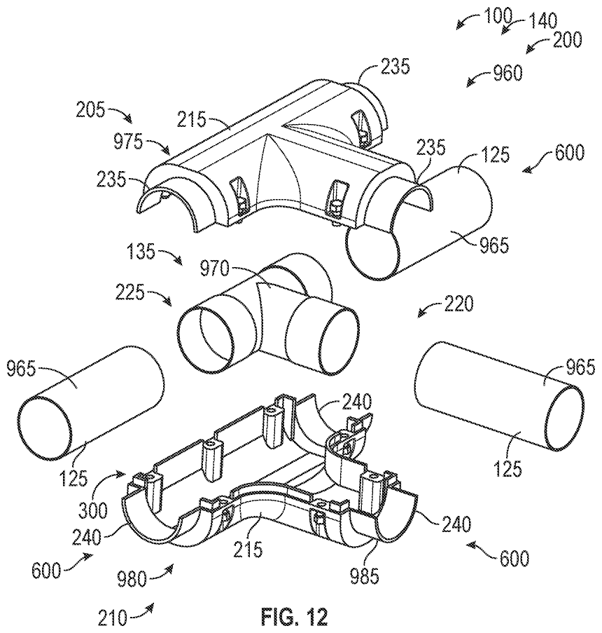

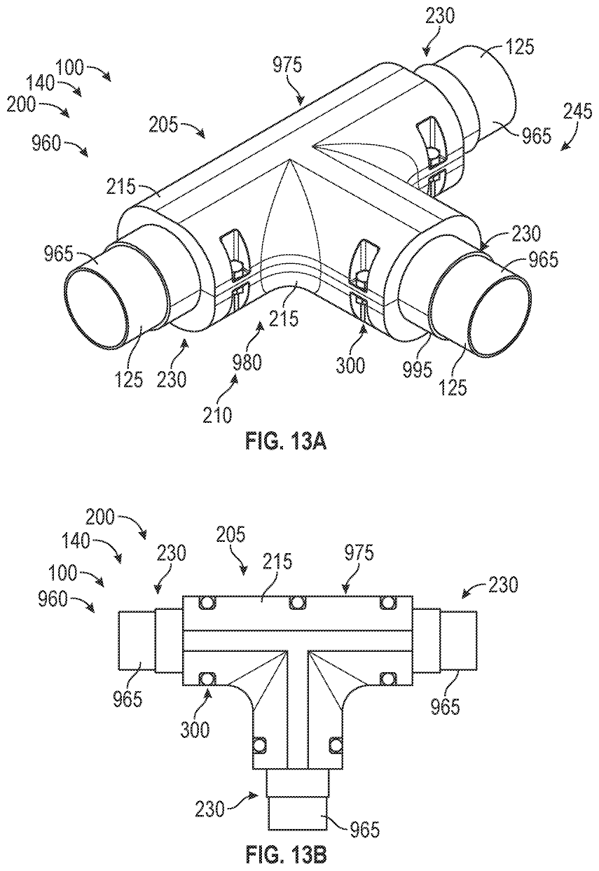

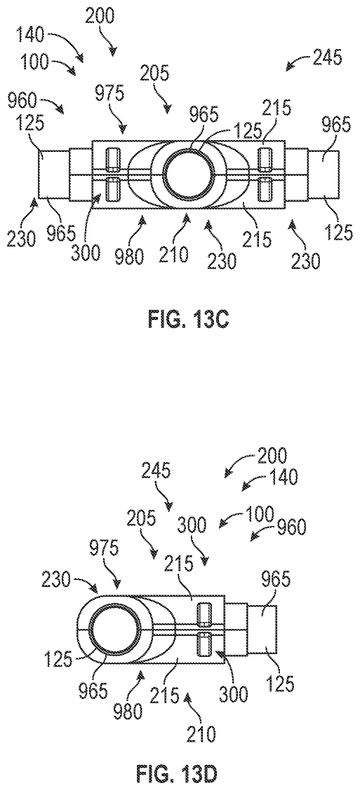

FIGS. 12 and 13A through 13D show another version of an underground pipe protection system 100 that is in the form of a Tee shaped underground pipe protection system 960. This version is particularly useful for attaching to existing installed pipes, particularly sewer pipes 965 that have a sanitary bull nose tee 970. A top tee part 975 and a bottom tee part 980 connect to one another and a tee slip insert flange 985 creates a watertight connection. The Tee shaped underground pipe protection system 960 allows dripline zones to be distributed.

The underground pipe protection system 100 can be made out of any suitable material. In one version, the underground pipe protection system 100 is made of polyvinyl chloride (PVC) or other plastic material, such a acrylonitrile butadiene styrene (ABS) or the like. In another version, the underground pipe protection system 100 is made out of one or more metals, such as copper or the like. In others version, the underground pipe protection system can be made out of stone, such as AQUA Ceramic Stone or out of clay or the like.

The underground pipe protection system 100 is useful for protecting any underground pipes, such as underground pipes used in a sprinkler system as discussed above. In other applications, the underground pipe protection system 100 can be used to protect pipes associated with a water supply system 900, as shown in FIG. 11A, a sewer or septic system 905 as shown in FIG. 11B, a gas supply system 910, as shown in FIG. 11C, and/or a gas distribution system 915, as shown in FIG. 11D. These are mere examples of the many possibilities for use in protecting any underground pipe and in particular protecting any underground pipe joint. In addition, the underground pipe protection system 100 can also be used to protect above ground systems or partially above ground systems, such as a faucet, a service line curb stop, a water supply service fitting, a corporation stop, a water supply service line, a water meter, a stop and waste valve, a sump pump, a backup water valve, a sewer trap, a server clean out, a sewer lateral, a sewer line service fitting, a sewer main clean out and sewer property line clean out, a gas meter, a service riser, an excess flow valve, a cutoff valve, a regulator and fuel line, and the like. The size and shape of the underground pipe protection system 100 can be adjusted based on the size and shape of the pipes or systems that are to be protected as would be understood by those skilled in the art.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. An underground pipe protection system for protecting an underground pipe joint, the system comprising:
a body comprising a top part and a bottom part that is connectable to the top part to define an interior space that is sized, shaped, and adapted to receive an underground pipe joint,
wherein the body comprises a plurality of pipe receiving openings, each opening being sized, shaped, and adapted to receive a pipe leading to the underground pipe joint, and
wherein the body provides a protective cover around at least a portion of the underground pipe joint that helps protect the underground pipe joint from one or more of root penetration, soil or ground movement, and water damage.

2. A system according to claim 1 wherein the body comprises a hard shell that provides the protective cover.

3. A system according to claim 1 wherein at least one of the plurality of pipe-receiving openings includes a portion of the opening in the top part and a portion of the opening in the bottom part.

4. A system according to claim 1 wherein at least one of the plurality of pipe-receiving openings is entirely in the bottom part.

5. A system according to claim 1 wherein at least one of the plurality of pipe-receiving openings is in the top part.

6. A system according to claim 1 wherein at least one of the plurality of pipe-receiving openings is in a sidewall portion of the body and wherein an additional pipe-receiving opening is in a top surface of the body.

7. A system according to claim 1 wherein the body is T-shaped.

8. A system according to claim 1 wherein at least one of the plurality of pipe-receiving openings resists the passage of water through the opening when a pipe is received in the opening.

9. An underground pipe protection system for protecting an underground pipe joint, the system comprising:
a body comprising a top part and a bottom part that is connectable to the top part to define an interior space; and
a pipe joint adapted to connect two or more underground pipes, the pipe joint being receivable in the interior space of the body,
wherein the body comprises a plurality of pipe receiving openings, each opening being sized, shaped, and adapted to receive a pipe leading to the pipe joint, and
wherein the body provides a protective cover around at least a portion of the pipe joint when the pipe joint is located underground so that the body helps protect the pipe joint from one or more of root penetration, soil or ground movement, and water damage.

10. A system according to claim 9 wherein the body comprises a hard shell that provides the protective cover.

11. A system according to claim 9 wherein at least one of the plurality of pipe-receiving openings includes a portion of the opening in the top part and a portion of the opening in the bottom part.

12. A system according to claim 9 wherein at least one of the plurality of pipe-receiving openings is entirely in the bottom part.

13. A system according to claim 9 wherein at least one of the plurality of pipe-receiving openings is in the top part.

14. A system according to claim 9 wherein at least one of the plurality of pipe-receiving openings is in a sidewall portion of the body and wherein an additional pipe-receiving opening is in a top surface of the body.

15. A system according to claim 9 wherein the body is T-shaped.

16. A system according to claim 9 wherein at least one of the plurality of pipe-receiving openings resists the passage of water through the opening when a pipe is received in the opening.

17. A method of protecting an underground pipe joint, the method comprising:
providing a body comprising a top part and a bottom part that is connectable to the top part to define an interior space that is sized, shaped, and adapted to receive an underground pipe joint, wherein the body comprises a plurality of pipe receiving openings, each opening being sized, shaped, and adapted to receive a pipe leading to the underground pipe joint; and
positioning the body to receive an underground pipe in each of the plurality of pipe receiving openings and to receiving at least a portion of an underground pipe joint in the interior space,
wherein the body provides a protective cover around at least a portion of the underground pipe joint that helps protect the underground pipe joint from one or more of root penetration, soil or ground movement, and water damage.

18. A method according to claim 17 wherein the plurality of pipe-receiving openings includes a portion of each opening in the top part and a portion of each opening in the bottom part so that the body can be installed on an existing underground pipe joint.

19. A method according to claim 17 wherein at least one of the plurality of pipe-receiving openings resists the passage of water through the opening when a pipe is received in the opening.

20. A method according to claim 17 wherein the top part is located above the bottom part in use.
